(19) United States
(12) Patent Application Publication
(10) Pub. No.: US 2007/0022613 A1
(43) Pub. Date: Feb. 1, 2007

(54) SCISSORS

(76) Inventors: David Carpenter, Jaffrey, NH (US); Christopher Aiston, Nashua, NH (US)

Correspondence Address: WHYTE HIRSCHBOECK DUDEK S.C., ONE EAST MAIN STREET, SUITE 300, MADISON, WI, 53703-3300, US

(21) Appl. No.: 11/382,534

(22) Filed: May 10, 2006

Related U.S. Application Data
(63) Continuation-in-part of application No. 10/293,235, filed on Nov. 13, 2002, now abandoned.
(60) Provisional application No. 60/338,576, filed on Nov. 13, 2001.

(51) Int. Cl. B26B 13/00

(52) U.S. Cl. 30/260

(57) ABSTRACT

An interchangeable blade scissors assembly is provided. The interchangeable blade scissors assembly has a pair of scissors frame members each having a blade receiving portion and a handle, a pivot connection of the pair of scissors frame members, and a plurality of pairs of cutting blades. Each of the cutting blades has a mounting plate and a latch. Each of the blade receiving portions has a channel for receiving the cutting blade mounting plate and a latch receiving area for securing the cutting blade to the blade receiving portions. The cutting blades are easily removed from the blade receiving portions by telescopic movement along the channel.

### CROSS REFERENCE TO RELATED APPLICATIONS

This application is a continuation-in-part of U.S. patent application Ser. No. 10/293,235 filed on Nov. 13, 2002, which is related to and claims the benefit of U.S. Provisional Application Ser. No. 60/338,576 filed on Nov. 13, 2001, the entirety of which are incorporated by reference herein.

### FIELD OF THE INVENTION

The present invention relates generally to cutting instruments. More particularly, the present invention relates to scissors having interchangeable blades.

### BACKGROUND OF THE INVENTION

Stationary products such as shears, trimmers, and scissors have evolved in functionality in recent years due to improvements in manufacture, assembly, operation, and design. The result has been development of safer and more efficient, as well as more innovative cutting instruments.

The industry continues to place increasing demand on manufacturers of stationary products to increase the ease of consumer operation of cutting instruments, as well as to provide an instrument, which can be rapidly manufactured and assembled. For example, scissors specifically designed for use by children require durability, safety, and novelty. By further example, scissors designed for adult use require efficiency in production and assembly in order to produce a market competitive product.

While various attempts have been made to achieve a product construction and assembly which enables a cutting instrument to be manufactured and produced at minimum expense, such efforts have failed to provide a final product which is capable of meeting all user demands. Prior efforts have also failed to produce scissors that meet design, structure, assembly, and operational ease. Consequently, a need exists for improvements in the manufacture and assembly of cutting instruments such as scissors.

Specifically, a need exists for an integrally formed cutting system having rapidly and easily changeable cutting elements. Such a cutting system would allow the user to quickly and safely change the cutting edge in order to enable the same scissors handles to be used in a wide variety of cutting configurations to achieve a wide variety of visual appearance for the paper or other medium being cut, while being easily transformable and safe for use by children.

### SUMMARY OF THE INVENTION

It is an object of the present invention to provide scissors having interchangeable blades, in which the scissors are constructed in a manner to enable it to be quickly and easily assembled, yet also easily and conveniently employed and adapted to multiple cutting styles.

It is also an object of the present invention to provide scissors having interchangeable blades, in which the blade assembly system is rugged and wear-resistant.

It is a further object of the present invention to provide scissors having a minimal number of components to produce the interchangeable blade construction.

It is a still further object of the present invention to provide scissors having interchangeable blades in which the blades may be removed and replaced with substantial ease and simplicity.

These and other objects and advantages are achieved by a cutting instrument having integrally formed, pivotally attached handles, which are capable of securely retaining a wide variety of cutting blades which are easily mounted thereto.

By employing the present invention, any user, including a child, can quickly and easily mount any desired cutting blades to the handles of the scissors. In order to attain this quick, simple, easily employed construction, cutting blade support members are constructed for telescopic sliding engagement with the support handles of the scissors. In addition, by incorporating a latch, which is easily locked in place, a unique scissor construction assembly is achieved.

In addition, the latch preferably also has an easily reached release member so that the removal of any desired cutting blade assembly is achieved, whenever the user desires to change or replace a cutting blade. In the preferred embodiment, the release member is integrally formed with the latch to assure a quick, simple and easy operation.

The foregoing and still other objects and advantages of the present invention will be more apparent from the following detailed explanation of the preferred embodiments of the invention in connection with the accompanying drawings, specification, and claims.

### BRIEF DESCRIPTION OF THE DRAWINGS

FIG. 1 illustrates an exploded perspective view of the interchangeable cutting blade scissors assembly of the present invention;

FIG. 2 illustrates a perspective view of the interchangeable cutting blade scissors assembly of the present invention, shown in the open position;

FIG. 3 illustrates a side view of the interchangeable cutting blade scissors assembly of FIG. 2, shown in the closed position;

FIG. 4 illustrates a side view depicting two interchangeable cutting blade members being

FIG. 5 illustrates a perspective view of the interchangeable blade scissors assembly of the present invention.

FIG. 6 illustrates a cross sectional view of the scissor blades taken along line 6 of FIG. 5.

### DETAILED DESCRIPTION OF THE INVENTION

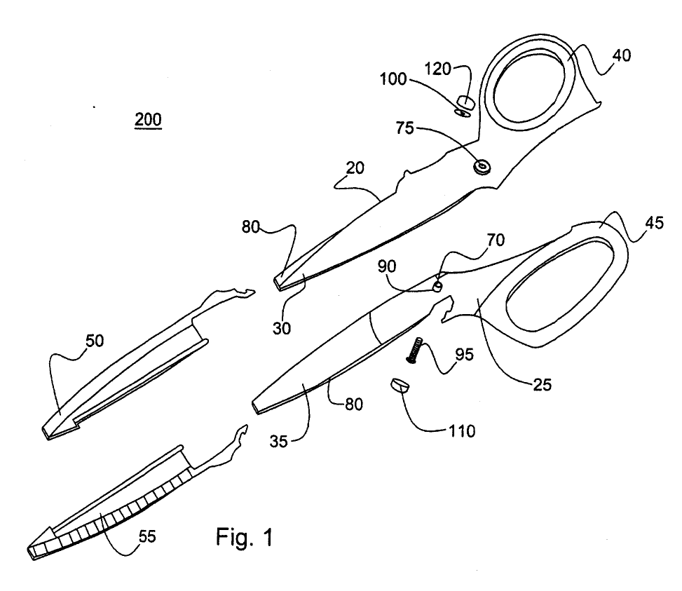

Referring to FIG. 1, the interchangeable cutting blade scissors assembly of the present invention is generally referred to as reference numeral 200. In the preferred embodiment, interchangeable cutting blade scissors assembly 200 incorporates scissors frame members 20 and 25. Each scissors frame member 20, 25 has a blade receiving arm portion 30, 35, respectively, at one end thereof, and a handle bow 40, 45, respectively, at an end opposite the blade receiving arm portions. Blade receiving arm portions 30, 35 serve as a support for interchangeable blade members 50, 55, respectively.

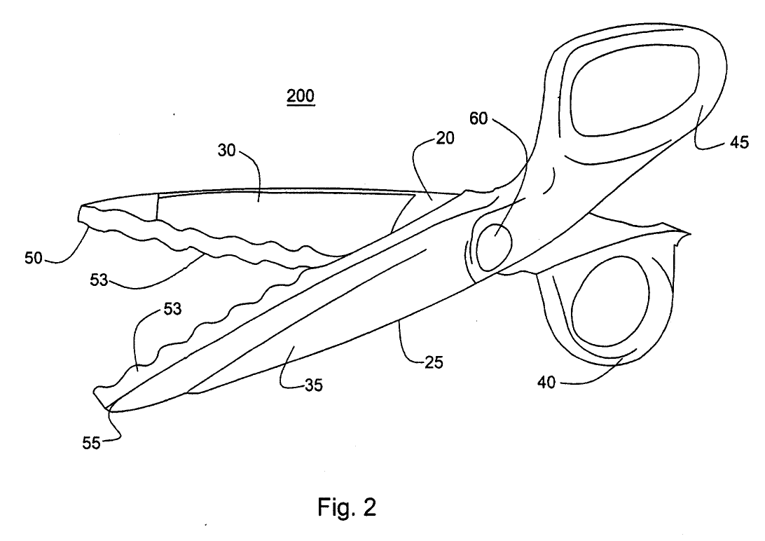

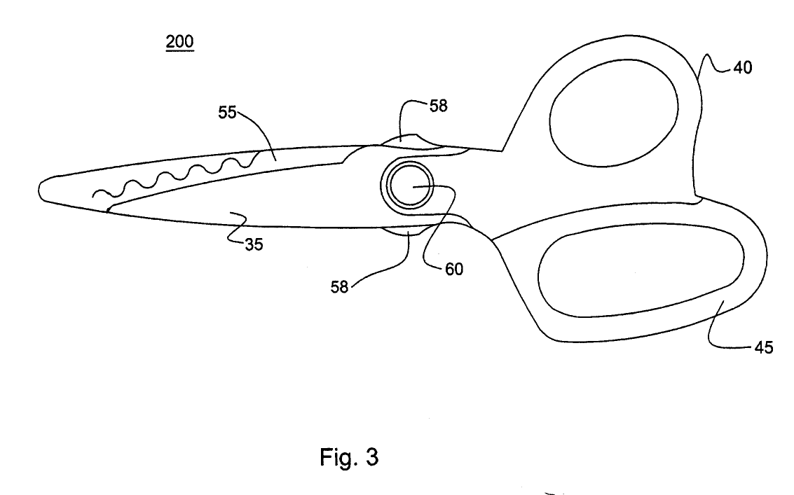

Referring to FIGS. 1 to 4, handle bows 40, 45 may be openings of identical size and shape, that can accommodate either right handed or left handed use. Preferably, as shown in FIGS. 1 to 4, a first scissors frame member has a substantially oblong finger or handle bow 45, sized to accommodate several fingers, and a second scissors frame member 20 has a substantially round thumb or handle bow 40 sized to accommodate the user's thumb.

Referring to FIG. 1, scissors frame members 20, 25 are securely mounted to each other by a pivot assembly 60, for cooperative movement about the axis defined thereby. Pivot assembly 60 may be a pin, screw, nut and bolt or any functional equivalent thereof. In the preferred embodiment, pivot assembly 60 has a post 90 integrally formed in scissors frame member 20. Post 90 has post through opening 70. Scissors frame member 25 has an aperture 75 formed therein. Interchangeable cutting blade scissors assembly 200 is assembled by passing post 90 through aperture 75. Bolt 95 and nut 100 secure scissors frame members 20, 25.

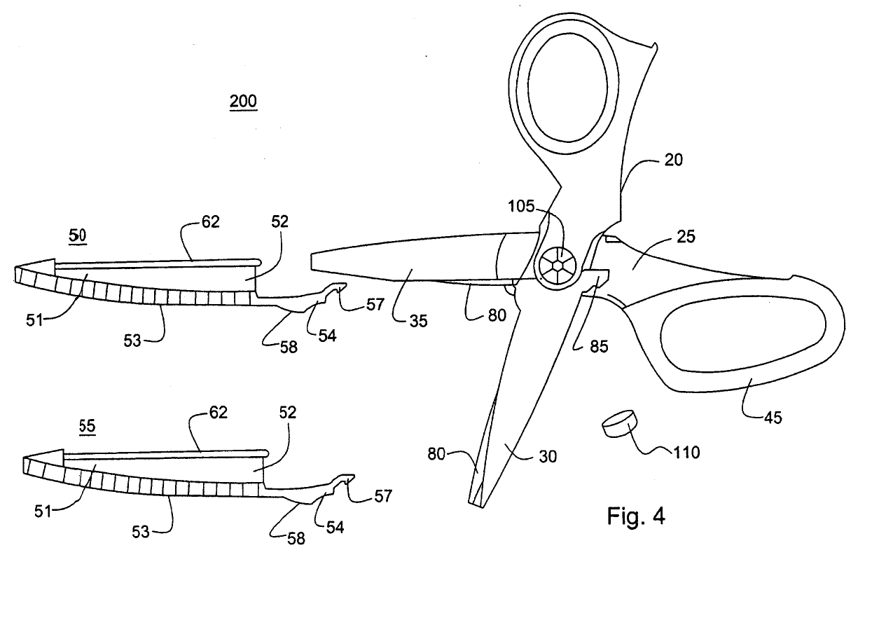

As shown in FIG. 4, depressions 105, 107 (not shown) are preferably located in the outward facing side of each of scissors frame members 20, 25, respectively. In the preferred embodiment, caps 110, 120 are secured by snap-fit into depressions 105, 107, respectively, for concealing pivot assembly 60.

Interchangeable blade members 50, 55 each have an elongated, generally tapered body portion 51 that incorporates a mounting plate 52, and a lip 62 at an edge of the mounting plate and a cutting surface 53 formed along one edge of the mounting plate. As depicted, cutting surface 53 has a generally sinusoidal, sawtooth, or angular configuration. However, cutting surface 53 may have any desired alternate configuration formed thereon, in order to achieve any desired cutting configuration.

To provide rapid engagement and disengagement of interchangeable blade members 50, 55 with scissors frame members 20, 25, respectively, the interchangeable blade members each have a locking finger 54 extending from mounting plate 52, positioned for engagement with its respective scissors frame member. In the preferred embodiment, locking finger 54 has a latch element 57 and a release surface 58. Latch element 57 is preferably a hook-type catch. In addition, interchangeable blade members 50, 55 are configured substantially identically to blade receiving arm portions 30, 35 respectively. Also, interchangeable blade members 50, 55 are constructed for secure, mounted engagement to blade receiving arm portions 30, 35 of scissors frame members 20, 25, respectively. For securement, lip 62 of each interchangeable blade member 50, 55 is positioned in a channel 80 of the respective blade receiving arm portion 30, 35.

To accommodate the secure, mounted engagement of interchangeable blade members 50, 55 with scissors frame members 20, 25, blade receiving arm portions 30, 35 of the scissors frame member have a mounting channel 80. The mounting channel 80 receives mounting plate 52 by telescopic movement of the mounting plate along the mounting channel, thereby enabling interchangeable blade members 50, 55 to be securely mounted blade receiving arm portions 30,35 in a rapid, easily achieved manner. In a preferred embodiment, a flange may be positioned on mounting plate 52 for providing increased stability of interchangeable blade members 50, 55 within blade receiving arm 30, 35.

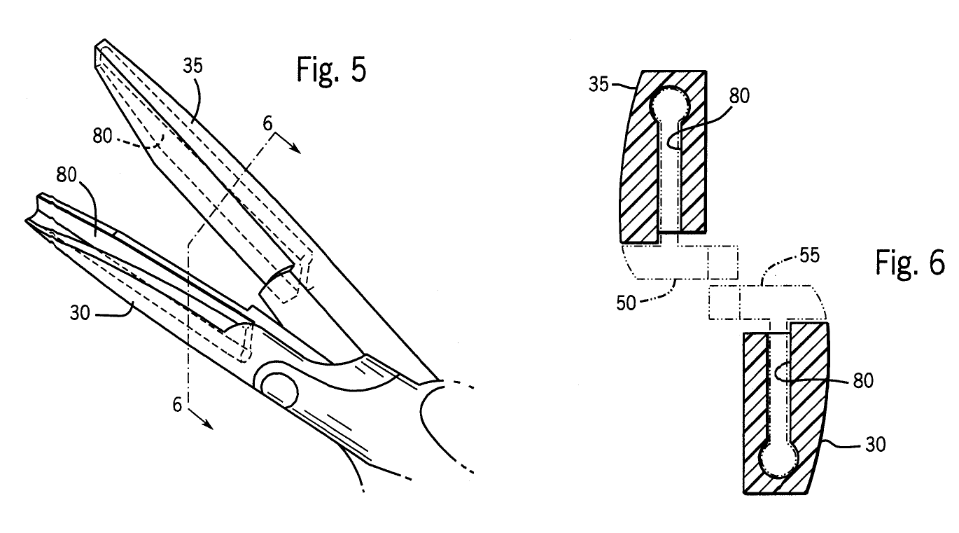

Now referring to FIG. 5, the preferred embodiment is shown from an alternate angle than the previous Figures. Blade receiving arm portions 30, 35 have a channel 80 on each respective arm portion. The dashed lines in FIG. 5 represent the structure of channel 80. As shown in FIG. 6, Channel 80 has a hairpin-like shape when viewed from the cross section. The channel structure 80 is the same as shown in FIGS. 1-4 and is configured to telescopically engage the blade receiving arm portions 30, 35 with the interchangeable blade members 50, 55. In an alternative embodiment (not shown), the channel 80 may have a reverse triangular cross sectional shape. In an alternative embodiment (not shown), the semi-circle shape of the hairpin channel 80 may be rectangular.

Each scissors frame member 20, 25 also has a latch receiving zone 85 formed along blade receiving arm portions 30, 35. The latch receiving zone 85 is positioned, and preferably configured, for cooperative engagement with locking finger 54 and latch element 57 thereof. Application of pressure to release surface 58 acts to bow locking finger 54 by flexible deformation of the locking finger, thereby disengaging latch element 57 from latch receiving zone 85 and allowing the respective interchangeable blade member 50, 55 to slide along mounting channel 80. Preferably, locking finger 54 is made of a flexible material, such as, for example, plastic or aluminum, that permits flexing of the locking finger.

Once interchangeable blade members 50, 55 have been mounted to blade receiving arm portions 30, 35, 25 respectively, the user can employ interchangeable cutter blade scissors assembly 200 of the present invention to attain the precisely desired cutting design provided by the blade members. In addition, whenever an alternate cutting design is desired, release surface 58 of interchangeable blade members 50, 55 are pressed towards each other, thereby releasing latch element 57 of each locking finger 54 from latch receiving zone 85, to enable the interchangeable blade members to be telescopically removed from blade receiving arm portions 30, 35 along mounting channel 80. Once removed, any alternate blade configuration can be employed by simply mounting the desired interchangeable blade members 50, 55 to blade receiving arm portions 30, 35, respectively.

Interchangeable cutting blades scissors assembly 200 preferably has an overmold of soft rubber, resin or similar material such as Sanaprene. The overmold provides safe and comfortable gripping of handle bows 40, 45.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1: An interchangeable blade scissors assembly comprising:
a pair of scissors frame members with each one of said pair having a blade receiving portion and a handle;
means for pivotal connection of said pair of scissors frame members; and
a pair of cutting blades, wherein each one of said pair of cutting blades has a mounting plate and a latch, and wherein each one of said blade receiving portions has a channel, each channel of said blade receiving portions for telescopically receiving one mounting plate and one latch said latch for selectively securing one of said pair of cutting blades to one of said blade receiving portions.

2: The interchangeable blade scissors assembly of claim 1, wherein each cutting blade of said pair of cutting blades has a locking finger.

3: The interchangeable blade scissors assembly of claim 1, wherein each cutting blade of said pair of cutting blades has a release surface.

4: The interchangeable blade scissors assembly of claim 1, wherein each of said pair of cutting blades has a cutting surface with a shape selected from the group consisting of a sinusoidal shape, a sawtooth shape, and an angular shape.

5: The interchangeable blade scissors assembly of claim 1, wherein each of said pair of scissors frame members has an aperture.

6: The interchangeable blade scissors assembly of claim 5, wherein said pivotal connection means is passed through each of said pair of scissors frame members through said aperture.

7: The interchangeable blade scissors assembly of claim 1, wherein one of said pair of scissors frame members has an aperture, and wherein another of said pair of scissors frame members has a mounting post adapted to fit in said aperture.

8: The interchangeable blade scissors assembly of claim 7, wherein said mounting post has a second aperture.

9: The interchangeable blade scissors assembly of claim 8, wherein said pivotal connection means is passed through said second aperture and said aperture.

10: The interchangeable blade scissors assembly of claim 1, wherein said pivot means further comprises a pair of pivot caps mounted to said pair of scissors frame members.

11: The interchangeable blade scissors assembly of claim 1, wherein said handles have an overmolded grip.

12: An interchangeable blade scissors assembly comprising:
a pair of scissors frame members each having a blade receiving portion and a handle;
means for pivotally connecting together said pair of scissors frame members; and
a plurality of cutting blades, wherein each of said plurality of cutting blades further comprises a mounting plate, a locking finger extending from said mounting plate, a latch disposed on a distal end of said locking finger, and a release surface, wherein each of said blade receiving portions has a channel for receiving one of said locking fingers, each channel of said blade receiving portion having a latch receiving area, each latch receiving area of each channel for securing one of said plurality of cutting blades to one of said blade receiving portions, and wherein each of said plurality of cutting blades has a different cutting edge.

13: A scissor comprising:
a first member and a second member being connected to one another by a pivot, said first member having a first channel therein, said second member having a second channel therein, said first channel having a first interior space having a first latch receiving zone, said second channel having a second interior space having a second latch receiving zone, wherein said first member and said second member move from a first opened position to a second closed position.

14: The scissor of claim 13, further comprising a first blade removably telescopically connected in said first channel, and a second blade removably telescopically connected in said second channel.

15: The scissor of claim 14, wherein said first blade has a first cutting edge, said first blade having a first end and a second end opposite said first end, said second end having a first latch element connected thereto.

16: The scissor of claim 15, wherein said second blade has a third end and a fourth end opposite said third end, said fourth end having a second latch element connected thereto.

17: The scissor of claim 16, wherein said first latch element is selectively connected to said first latch receiving zone, and wherein said second latch element is selectively connected to said second latch receiving zone.

18: The scissor of claim 17, wherein said first latch element and said second latch element are disengaged by a button.
